(19) United States
(12) Patent Application Publication
(10) Pub. No.: US 2015/0043364 A1
(43) Pub. Date: Feb. 12, 2015

(54) DYNAMIC ROUTING METHOD IN AD-HOC NETWORK AND NETWORK DEVICE THEREFOR

(71) Applicant: INTELLECTUAL DISCOVERY CO., LTD., Seoul (KR)

(72) Inventors: Hyun Kook Kahng, Seoul (KR); Dae In Choi, Suwon-si (KR); Min Su Kim, Suwon-si (KR); Se Joon Yoon, Siheung-si (KR)

(73) Assignee: INTELLECTUAL DISCOVERY CO., LTD., Seoul (KR)

(21) Appl. No.: 14/376,379

(22) PCT Filed: Feb. 1, 2013
(86) PCT No.: PCT/KR2013/000842

§ 371 Date: Oct. 22, 2014

(30) Foreign Application Priority Data
Feb. 3, 2012 (KR) 10-2012-0011237

(51) Int. Cl. H04L 12/759; H04L 12/26; H04L 12/721

(52) U.S. Cl. CPC H04L 45/028; H04L 45/44; H04L 43/50
USPC 370/252; 370/328

(57) ABSTRACT

A dynamic routing method of a network device in an ad-hoc network is provided. The method includes (a) collecting a factor comprising at least one of the number of neighboring network devices, a moving speed and an amount of data traffic; (b) setting a routing information transmission mode based on a value of the collected factor; and (c) processing at least one of transmission and non-transmission of routing information according to the set routing information transmission mode, wherein in the step (b), when setting the routing information transmission mode, if the value of the factor is less than a preset threshold value, the routing information transmission mode is set to an active mode, and if the value of the factor exceeds the threshold, the routing information transmission mode is set to an inactive mode.

### TECHNICAL FIELD

The embodiments described herein pertain generally to a dynamic routing method in an ad-hoc network and a network device therefor.

### BACKGROUND ART

In general, wireless networks may be divided into an infra-based network and an ad-hoc network. In case of the infra-based wireless network, relay equipment such as a base station and an access point is necessary for communication between terminals. The infra-based wireless network enables communication between terminals by providing an access point to terminals within a management range of the relay equipment, but is disadvantageous in that it requires a broad transmission range for the access point. On the other hand, in case of the ad-hoc network, an independent network can be formed in an infrastructure by using direct communication between terminals.

The ad-hoc network is a network method for network devices of users having mobility such as the military, a rescue party and vehicles, consists of a group of multiple terminals, and enables communication between terminals without requiring infrastructures such as a base station and an access point.

A routing protocol on the ad-hoc network may be divided into a topology-based routing protocol and a location-based routing protocol.

Specifically, the topology-based routing protocol may be divided by “proactive,” “reactive,” “hybrid” methods. The “proactive routing protocol” holds information about entire nodes through periodic routing message exchange among hosts so as to have low delay time, while being disadvantageous in that routing overheads rapidly increase as a network size and node mobility increase. While the “reactive routing protocol” implements route finding for a corresponding destination only when a connection request is made so that overheads of routing message exchange are small, it is disadvantageous in that time delay results from the route finding. The “hybrid routing protocol” takes advantages of the “proactive” and “reactive” methods.

In addition, the location-based routing protocol may be divided by “GPSR,” “DREAM,” and “LAR” methods. The “DREAM” method enables every node to hold location information for entire nodes, and determines location information renewal depending on a relative distance among nodes and a movement pattern of nodes. The “LAR” method limits broadcasting of a route request message to a specific area.

Meanwhile, in the ad-hoc network environment, a “broadcast storm” problem may occur due to broadcast messages to be transmitted by a multiple number of nodes implementing the above-described routing protocol.

In order to resolve the routing overhead problem, a routing protocol has been conventionally implemented by applying various methods. For example, in the “probabilistic scheme,” each host, which has received a broadcast message, determines whether to retransmit the broadcast message depending on a probability and transmits the broadcast message. In the “counter-based scheme,” when at least a specific number of broadcast messages are received after a host queues for a random time, a broadcast message is retransmitted. In the “distance-based scheme,” a certain distance, to which a broadcast message will be retransmitted, is preset, and a broadcast message is retransmitted only within the set range. In the “location-based scheme,” a range, which a previously transmitted broadcast message could not have reached, is calculated, and a broadcast message is retransmitted when the range to be newly reached is a certain range or more. In the “cluster-based scheme,” a cluster of nodes is formed by using ID to determine whether to retransmit a broadcast message depending on a performance of each host.

However, the above-described conventional methods to resolve routing overheads could have suggested no solution to reduce routing overheads by actively applying a routing method according to the state of an ad-hoc network, to which a network device belongs, and a network device.

Meanwhile, with respect to a technology related to example embodiments, Korean Patent Application Publication No. 2006-0065971 (Neighboring Node Management and Routing Path Setting Method in Mobile Ad-Hoc Network Environment and Network Device Using the Same) describes a method and an apparatus, which receive a broadcasted packet from a neighboring node, measure link quality for the neighboring node through the broadcasted packet to calculate a routing path with the neighboring node, and set a routing path having the shortest path to a destination node to a packet transmission path.

### DISCLOSURE OF INVENTION

### Technical Problems

In view of the foregoing problems, example embodiments provide a method capable of processing dynamic routing in an ad-hoc network environment and a network device implementing the same.

### Means for Solving the Problems

In one example embodiment A dynamic routing method of a network device in an ad-hoc network, comprising: (a) collecting a factor comprising at least one of the number of neighboring network devices, a moving speed and an amount of data traffic; (b) setting a routing information transmission mode based on a value of the collected factor; (c) processing at least one of transmission and non-transmission of routing information according to the set routing information transmission mode,

In the step (b), when setting the routing information transmission mode, if the value of the factor is less than a preset threshold value, the routing information transmission mode is set to an active mode, and if the value of the factor exceeds the threshold, the routing information transmission mode is set to an inactive mode.

In another example embodiment, A network device of an ad-hoc network, comprising: a network state monitoring unit that collects a factor comprising at least one of the number of neighboring network devices, a moving speed, and an amount of data traffic; a routing mode setting unit that sets a routing information transmission mode to an active mode if a value of the factor is less than a preset threshold, and the routing information transmission mode to an inactive mode if the value of the factor exceeds the threshold; and a transmitter that transmits or does not transmit routing information to another network device according to the set routing information transmission mode.

### EFFECT OF THE INVENTION

In accordance with the above-described example embodiments, by implementing dynamic routing, which processes transmission or non-transmission of routing information of a network device in an ad-hoc network based on the state (environment) of a network device or the ad-hoc network, routing overheads in the ad-hoc network can be reduced, so that a transmission rate of packets can increase, and traffic delay time can be reduced.

Furthermore, in accordance with the above-described example embodiments, transmission of routing information can be actively processed according to the number of neighboring networks transmitting and receiving data with a network device, the amount of data traffic to be processed by a network device, and the movement state (speed and direction, etc.) of a network device.

### BRIEF DESCRIPTION OF THE DRAWINGS

FIG. 1 is a block diagram showing configuration of a network device processing dynamic routing in an ad-hoc network in accordance with an example embodiment.

FIG. 2 shows a dynamic routing algorithm of a network device in accordance with an example embodiment.

FIG. 3 is a flow chart showing a dynamic routing method in accordance with an example embodiment.

FIG. 4 is a flow chart showing a method for setting a routing information transmission mode in accordance with the example embodiment.

### MODE FOR CARRYING OUT THE INVENTION

Hereinafter, example embodiments will be described in detail with reference to the accompanying drawings so that inventive concept may be readily implemented by those skilled in the art. However, it is to be noted that the present disclosure is not limited to the example embodiments but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element and include both a case where an element is “directly connected or coupled to” another element and a case where an element is “electronically connected or coupled to” another element via still another element. In addition, the term “comprises or includes” and/or “comprising or including” used in the document means that one or more other components, steps, operations, and/or the existence or addition of elements are not excluded in addition to the described components, steps, operations and/or elements.

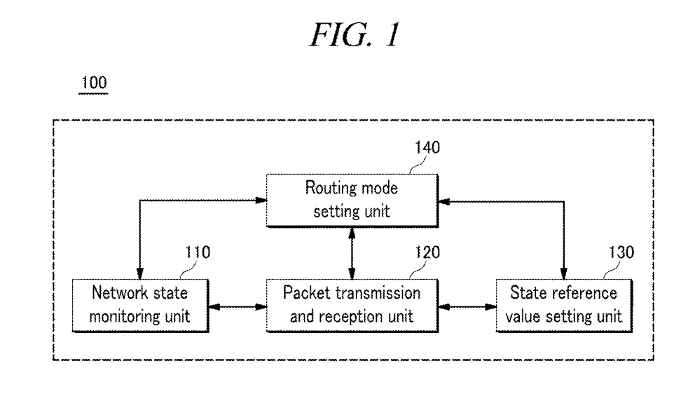

FIG. 1 is a block diagram showing configuration of a network device processing dynamic routing in an ad-hoc network in accordance with an example embodiment.

As illustrated in FIG. 1, a network device 100 in accordance with an example embodiment includes a network state monitoring unit 110, a routing mode setting unit 120, a packet transmission and reception unit 130, and a state reference value setting unit 140.

The network device 100 in accordance with the example embodiment illustrated in FIG. 1 is a node transmitting and receiving data in an ad-hoc network, and may be, for example, a wireless or mobile node. The network device 100 may transmit its routing information to another network device, for example, through a multicast or broadcast method.

The network state monitoring unit 110 collects, in real time or periodically, a factor for at least one of the number of neighboring network devices of the network device 100, a moving speed of the network device 100, and an amount of data traffic, and identifies values of the collected factors to send them to the routing mode setting unit 120.

The network state monitoring unit 110 may measure an amount of data traffic of the network device 100 itself or collect an amount of data traffic of a multiple number of network devices on the ad-hoc network. An amount of data traffic to be collected may be an amount of data traffic for at least one of a packet, which is transmitted and received to be directly processed by the network device, and a packet, which has been forwarded to another network device. The network state monitoring unit 110 may directly collect an amount of data traffic from the packet transmission and reception unit 130 or through the state reference value setting unit 140.

The network state monitoring unit 110 may determine a neighboring network device of the network device 100 depending on the conditions set forth below.

For example, when a physical size of the ad-hoc network is D, the network device is N, a maximum data transmission distance of the network device is r, and a distance between a network device Ni and a network device Nj is lNi-Njl, in case of lNi-Njl≦r, the network devices Ni and Nj may be neighboring network devices.

The network state monitoring unit 110 may calculate an average number of neighboring network devices of the network device 100.

$$n ( {AN}_{D} ) = \frac{n ( {T}_{D} ) π {r}^{2}}{D} = \frac{\begin{matrix}( the number of nodes of a network D ) π \\ {( maximum transmission distance )}^{2}\end{matrix}}{a physical network size} \qquad [ Math Formula 1 ]$$

In this case, n(AND) is the average number of neighboring network devices of Ni, and n(T_{D}) is the number of network device D.

The routing mode setting unit 120 sets a routing information transmission mode of the network device 100 based on the values of the collected factors.

Specifically, the routing mode setting unit 120 sets a routing information transmission mode to an active mode when a value of the collected factor is less than a preset threshold, and the routing information transmission mode to an inactive mode when a value of the factor exceeds the threshold.

The active mode is a mode, in which the network device 100 transmits routing information to another network device in a preset cycle or at a preset time point, and the inactive mode is a mode, in which the network device 100 does not transmit routing information in the cycle or at the time point. The routing information may include at least one of location information and a routing table of the network device 100.

The routing mode setting unit 120 may set a routing information transmission mode by comparing a general factor value calculated based on values of all factors by types or a value of each factor with its corresponding threshold. That is, the routing mode setting unit 120 may set a routing information transmission mode according to any one of types of factors, and may also set a routing information transmission mode by generally taking all factors into consideration.

Meanwhile, the routing mode setting unit 120 may identify a routing information transmission mode previously set for the network device 100, and hold the previous routing information transmission mode or change it into a routing information transmission mode set according to conditions indicated by a currently collected factor, i.e., the network state. The routing mode setting unit 120 may identify the value of the collected factor in a preset cycle or at a preset time point to set the routing information transmission mode.

In addition, the routing mode setting unit 120 may set a routing information transmission mode according to the conditions set forth below, when setting a routing information transmission mode by comparing a value of a factor with a threshold.

The routing mode setting unit 120 may set a routing information transmission mode to an inactive mode according to a preset probability if the value of the collected factor exceeds a threshold.

For example, when a threshold, at which the transition state between an active mode and an inactive mode will occur in the network D occurs, is th_{D}, the average number of neighboring nodes of the network device Ni is n(NE(Ni)), and the probability that the network device (Ni) will become an inactive mode is Pr(Ni), the probability can be calculated through Math Formula 2 below.

$${P}_{r} ( {N}_{i} ) = \frac{n ( NE ( {N}_{1} ) - {th}_{D}}{n ( NE ( {N}_{i} )} \qquad [ Math Formula 2 ]$$

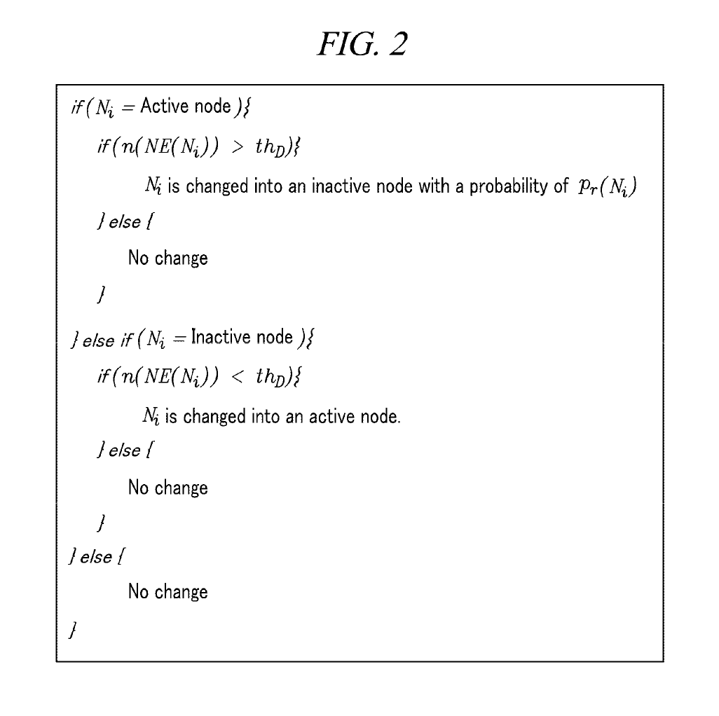

That is, the routing mode setting unit 120 in accordance with an example embodiment may set a routing information transmission mode of the network device 100 through a routing information transmission mode setting algorithm shown in FIG. 2.

FIG. 2 shows a dynamic routing algorithm of a network device in accordance with an example embodiment.

FIG. 2 presents the network device 100 as a node on a network, and shows an algorithm in the case where a collected factor and a type of a threshold are average neighboring network devices, i.e., neighboring nodes.

According to the algorithm shown in FIG. 2, when the network device Ni is preset to an active node, if it is determined that the average number of neighboring nodes n(NE(Ni)) of the network device Ni is greater than the threshold dip, the network device Ni is changed into a node of an inactive mode with a probability of Pr(Ni), and if the average number of neighboring nodes is less than the threshold, the active mode state is held (namely, “no change”).

On the other hand, when the network device Ni is preset to an inactive node, if it is determined that the average number of neighboring nodes n(NE(Ni)) is smaller than the preset threshold Um, the network device Ni is changed into a node of an active mode, and if the average number of neighboring nodes is greater than the threshold, the inactive mode state is held (“no change”).

Returning to FIG. 1, the packet transmission and reception unit 130 transmits and receives a packet to be directly processed by the network device 100 or a packet to be forwarded to another network device.

In this case, the packet transmission and reception unit 130 in accordance with an example embodiment determines whether to transmit routing information of the network device 100 based on a routing information transmission mode set through the routing mode setting unit 120.

That is, if the routing information transmission mode of the network device 100 is an active mode, the packet transmission and reception unit 130 transmits the routing information to another network device in a preset cycle or at a preset time point. On the other hand, if the routing information transmission mode of the network device 100 is an inactive mode, the packet transmission and reception unit 130 does not transmit the routing information in a preset cycle or at a preset time point.

By implementing dynamic routing, which transmits or does not transmit routing information on the ad-hoc network based on the state of the network device 100, the network device 100 in accordance with an example embodiment can reduce routing overheads on the ad-hoc network, so that a transmission rate of packets can increase, and traffic delay time can be reduced.

The state reference value setting unit 140 sets the threshold based on the data transmission state of the network device 100 or the ad-hoc network, and sends the set threshold to the routing mode setting unit 120. The state reference value setting unit 140 may extract a previously set and stored threshold to provide it to the routing mode setting unit 120. In this case, the state reference value setting unit 140 may set a threshold for each of the factors by types. For example, the state reference value setting unit 140 may set each threshold based on the number of neighboring network devices, a moving speed, a moving direction and an amount of data traffic, and the size of the threshold may be changed.

On the ad-hoc network, to which an example embodiment is applied, identical or different thresholds may be set for a multiple number of network devices.

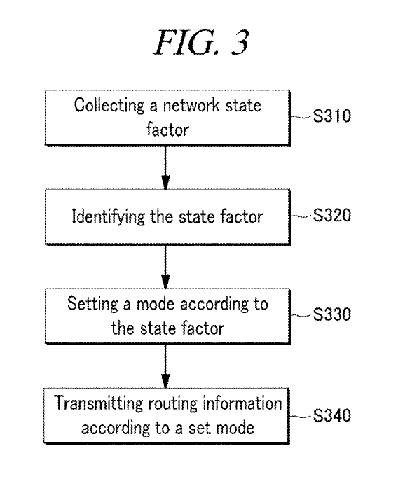

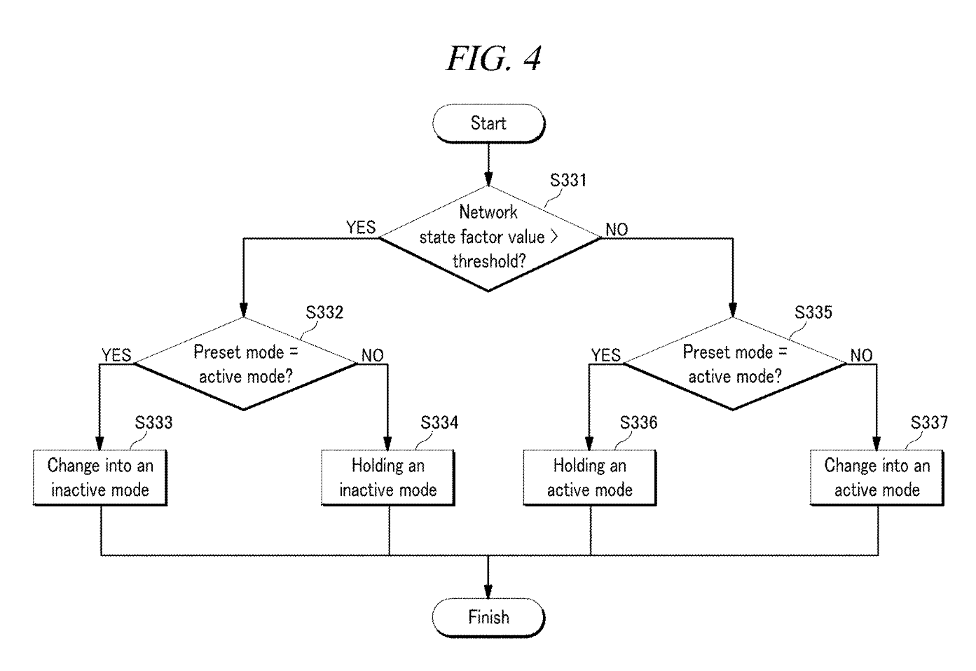

Hereinafter, the dynamic routing method on the ad-hoc network in accordance with an example embodiment will be described in detail with reference to FIG. 3 and FIG. 4.

FIG. 3 is a flow chart showing a dynamic routing method in accordance with an example embodiment.

First, a factor, which is preset in type, and of which value varies depending on the state of the ad-hoc network, to which a network device belongs, is collected (S310).

The factor includes at least one the number of neighboring network devices of a certain network device, a moving speed and an amount of data traffic.

A value of the collected factor is identified (S320), and a routing information transmission mode is set based on the collected factor (S330).

First, the value of the collected factor is compared with a preset threshold to determine an active or inactive mode. Next, it is determined whether to hold or change a preset routing information transmission mode. A routing information transmission mode is set according to the result of the determination.

If the value of the factor is less than the threshold, a routing information transmission mode is set to an active mode, and if the value of the factor exceeds the threshold, the routing information transmission mode is set to an inactive mode.

Meanwhile, the routing information transmission mode in accordance with an example embodiment may be set through the method illustrated in FIG. 4 as set forth below.

FIG. 4 is a flow chart showing a method for setting a routing information transmission mode in accordance with an example embodiment.

First, the value of the collected factor according to the network state is compared with the preset threshold (S331).

As a result of the determination in S331, if the value of the collected factor exceeds the threshold, it is determined whether the preset routing information transmission mode is an active or inactive mode (S332).

As a result of the determination in S332, if the preset routing information transmission mode is an active mode, the active mode is changed into an inactive mode (S333), and if the preset routing information transmission mode is an inactive mode, the inactive mode is held (S334).

As a result of the determination in S331, if the value of the collected factor is less than the threshold, it is determined whether a routing information transmission mode preset in the network device is an active or inactive mode (S335).

As a result of the determination in S335, if the preset routing information transmission mode is an active mode, the active mode is held (S336), and if the preset routing information transmission mode is an inactive mode, the inactive mode is changed into an active mode (S337).

If the preset routing information transmission mode is an active mode, the active mode may be changed into an inactive mode according to a preset probability, and the probability may be set based on the average number of neighboring network devices of the network device and the threshold.

Returning to FIG. 3, routing information of the network device is processed to be transmitted according to the routing information transmission mode set in S330 (S340).

If the set routing information transmission mode is an active mode, the routing information of the network device is transmitted to another network device in a preset cycle or at a preset time point. On the other hand, if the set routing information transmission mode is an inactive mode, the routing information is not transmitted to another network device in the cycle or at the time point.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the example embodiments. It shall be understood that all modifications and embodiments conceived from the meaning and scope of the claims and their equivalents are included in the scope of the inventive concept.

We claim:

1. A dynamic routing method of a network device in an ad-hoc network, comprising:
(a) collecting a factor comprising at least one of the number of neighboring network devices, a moving speed and an amount of data traffic;
(b) setting a routing information transmission mode based on a value of the collected factor; and
(c) processing at least one of transmission and non-transmission of routing information according to the set routing information transmission mode,
wherein in the step (b),
when setting the routing information transmission mode, if the value of the factor is less than a preset threshold value, the routing information transmission mode is set to an active mode, and if the value of the factor exceeds the threshold, the routing information transmission mode is set to an inactive mode.

2. The dynamic routing method of a network device in an ad-hoc network of claim 1, wherein in the step (c),
in case of the active mode, the routing information is transmitted in a preset cycle or at a preset time point, and
in case of the inactive mode, the routing information is not transmitted in the cycle or at the time point.

3. The dynamic routing method of a network device in an ad-hoc network of claim 1, wherein the step (b) comprises:
comparing the value of the factor with the threshold to determine the active or inactive mode;
determining whether to hold or change the preset routing information transmission mode; and
setting the routing information transmission mode according to the result of the determination.

4. The dynamic routing method of a network device in an ad-hoc network of claim 1,
wherein in the step (b),
if the value of the factor exceeds the threshold, the routing information transmission mode is set to the inactive mode according to a preset probability, and
the probability is set based on the average number of neighboring network devices of the network device and the threshold.

5. The dynamic routing method of a network device in an ad-hoc network of claim 1,
wherein the amount of data traffic is an amount of data traffic of at least one of at least one transmission packet and at least one reception packet among the network device and a plurality of network devices on the ad-hoc network, and a packet to be forwarded to another network device.

6. A network device of an ad-hoc network, comprising:
a network state monitoring unit that collects a factor comprising at least one of the number of neighboring network devices, a moving speed, and an amount of data traffic;
a routing mode setting unit that sets a routing information transmission mode to an active mode if a value of the factor is less than a preset threshold, and the routing information transmission mode to an inactive mode if the value of the factor exceeds the threshold; and
a transmitter that transmits or does not transmit routing information to another network device according to the set routing information transmission mode.

7. The network device of an ad-hoc network of claim 6,
wherein the routing mode setting unit holds or changes a preset routing information transmission mode preset according to the routing information transmission mode set based on the value of the factor.

8. The network device of an ad-hoc network of claim 6,
wherein the routing mode setting unit sets the routing information transmission mode to the inactive mode according to a preset probability if the value of the factor exceeds the threshold,
and the probability is set based on the number of neighboring network devices of the network device and the threshold.

9. The network device of an ad-hoc network of claim 6,
wherein in case of the inactive mode, the transmitter transmits the routing information in a preset cycle or at a preset time point, and in case of the active mode, the transmitter does not transmit the routing information in the cycle or at the time point.

10. The network device of an ad-hoc network of claim 6,
wherein the amount of data traffic is an amount of data traffic of at least one of at least one transmission packet and at least one reception packet among the network device and a plurality of network devices on the ad-hoc network, and a packet to be forwarded to another network device.
